(19) United States
(12) Patent Application Publication
(10) Pub. No.: US 2022/0069434 A1
(43) Pub. Date: Mar. 3, 2022

(54) Telecommunications Pole Topper

(71) Applicant: ORIGIN Engineering LLC, Windsor, CO (US)

(72) Inventors: Matthew J. Chase, Windsor, CO (US); Graham Powers, Windsor, CO (US)

(21) Appl. No.: 17/445,899

(22) Filed: Aug. 25, 2021

Related U.S. Application Data
(60) Provisional application No. 62/706,609, filed on Aug. 28, 2020.
(60) Provisional application No. 63/199,910, filed on Feb. 2, 2021.

(51) Int. Cl. H01Q 1/12

(52) U.S. Cl. CPC H01Q 1/1242; H01Q 1/125; H01Q 1/1228

(57) ABSTRACT

An example telecommunications pole topper includes an axisymmetric centerline support structure configured for mounting at least one telecommunications antenna. A shroud closes off an interior voided area formed between the shroud and the centerline support structure. A universal multiple-axis adjustable bracket is configured to move up and down and around the centerline support structure when mounted thereto. The multiple-axis adjustable bracket together with the centerline support structure provides a mounting structure within the interior voided section of the shroud for mounting the at least one telecommunications antenna to the centerline support structure for 360 degrees of rotation about the centerline support structure. The support structure within the shroud accommodates different antenna sizes and shapes of telecommunications antennas and different mounting configurations to support a plurality of telecommunications coverage patterns.

### PRIORITY CLAIM

This application claims the priority benefit of U.S. Provisional Patent Application No. 62/706,609 filed on Aug. 28, 2020 for “Telecommunications Pole Topper” of Matthew J. Chase, et al., and U.S. Provisional Patent Application No. 63/199,910 filed on Feb. 2, 2021 for “Telecommunication Pole Topper” of Matthew J. Chase, each hereby incorporated by reference for all that is disclosed as though fully set forth herein.

### BACKGROUND

To make 5G wireless services a reality, small cell sites are being installed to provide coverage. 5G small cell sites must be lower to the ground and in closer proximity to one another than previous generations of wireless telecommunications. In dense, urban areas, 5G small cell sites are being installed all over city streets, buildings, and neighborhoods. To avoid clutter, cell phone carriers and municipalities recognize that existing light poles and power poles provide platforms for 5G small cell sites. Hence highly integrated pole toppers are needed to meet the requirements for providing wireless service while minimizing disruption during installation and repairs. These integrated poles will become common in the landscape and thus need to fit in seamlessly with the surroundings, while complying with local, state, and federal ordinances, while still based on a standard for manufacturing and installation.

To make 5G wireless services a reality, small cell sites are being installed to provide coverage. 5G small cell sites must be lower to the ground and in closer proximity to one another than previous generations of wireless telecommunications. In dense, urban areas, 5G small cell sites are being installed all over city streets, buildings, and neighborhoods. To avoid clutter, cell phone carriers and municipalities recognize that existing light poles and power poles provide platforms for 5G small cell sites. Hence highly integrated pole toppers are needed to meet the requirements for providing wireless service while minimizing disruption during installation and repairs. These integrated poles will become common in the landscape and thus need to fit in seamlessly with the surroundings, while complying with local, state, and federal ordinances, while still based on a standard for manufacturing and installation.

### BRIEF DESCRIPTION OF THE DRAWINGS

FIG. 1 shows an example telecommunications pole topper mounted on a pole.

FIG. 2 is a detailed view of an example pole mounting area shown in detail area A in FIG. 1.

FIG. 3 is a detailed view of the example telecommunications pole topper shown in detail area B in FIG. 1.

FIG. 4 shows an example mounting area for the telecommunications pole topper on a pole.

FIG. 5 is a detailed view of the example mounting area for the telecommunications pole topper on the pole shown in detail area C in FIG. 4.

FIGS. 6A-D show an example pole cover which may be implemented with the telecommunications pole topper, wherein A) is a perspective view, B) is a front view, C) is a side view, and D) is a top view.

FIG. 7 is a close up perspective view of the example telecommunications pole topper corresponding to FIGS. 1 and 3.

FIG. 8 shows the example telecommunications pole topper corresponding to FIG. 7, with the shroud removed to show interior detail.

FIG. 9 is a top perspective view showing the example telecommunications pole topper corresponding to FIG. 7, with another cover removed to show interior detail.

FIG. 10 is a bottom perspective view showing the example telecommunications pole topper corresponding to FIG. 7, with another cover removed to show interior detail.

FIG. 11 is a perspective view of an example top assembly of the example telecommunications pole topper.

FIGS. 12-15 are perspective views of an example bracket assembly of the example telecommunications pole topper.

FIGS. 16-17 are perspective views of an example vortex of the example telecommunications pole topper.

FIG. 18 is a perspective view of an example antenna attachment assembly of the example telecommunications pole topper.

FIGS. 19 and 20 are perspective views of an example shroud of the example telecommunications pole topper.

FIG. 21 is a perspective view of an example grate for the shroud of the example telecommunications pole topper.

FIG. 22 shows another example telecommunications pole topper.

FIG. 23A shows an example shroud of the example telecommunications pole topper shown in FIG. 22.

FIG. 23B is a detailed view of an example vent area of the shroud shown in detail area D in FIG. 23A.

FIG. 23C is a detailed view of an example vent area of the shroud shown in detail area E in FIG. 23B.

FIG. 24 is an exploded perspective view of an example internal structure of the example telecommunications pole topper shown in FIG. 22.

FIG. 25A is a detailed perspective view of an example hanger of the internal structure shown in FIG. 24.

FIG. 25B is a detailed perspective view of the example hanger shown in FIG. 25A with a threaded eye-bolt.

FIG. 26 is a perspective view of an example crane which may be implemented to install the example telecommunications pole topper shown in FIG. 22.

FIG. 27 is a perspective view of an example cap that may be implemented to self-level a telecommunications pole topper on an existing pole.

### DETAILED DESCRIPTION

A telecommunication pole topper is disclosed which provides an easier to install and upgrade solution that is resistant to both water and thermal radiation from the sun. The telecommunication pole topper is faster to build, and more cost effective to build. An example of the telecommunication pole topper system includes a pole cap that eliminates topper leveling issues.

The example telecommunication pole topper is constructed of lightweight material and has a lightweight design with a centerline support structure and shroud. In an example, the telecommunication pole topper enables cost effective installation and maintenance of telecommunications antennas (e.g., 5G antennas). For example, sand cast components enable mass production for cost effectiveness. In an example, heat generated by the telecommunications equipment is effectively transferred by vortex air circulation within the structure. The structure is readily opened and provides easy access, even behind antennas installed in the housing.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. By way of illustration, the pole topper is not limited to use with omnidirectional antennas or to any particular installation location. For example, the pole topper may be installed on other pole toppers, wood poles, aluminum poles, concrete poles, and other structures (e.g., roof tops). Other devices and/or device configurations may be utilized to carry out the operations described herein.

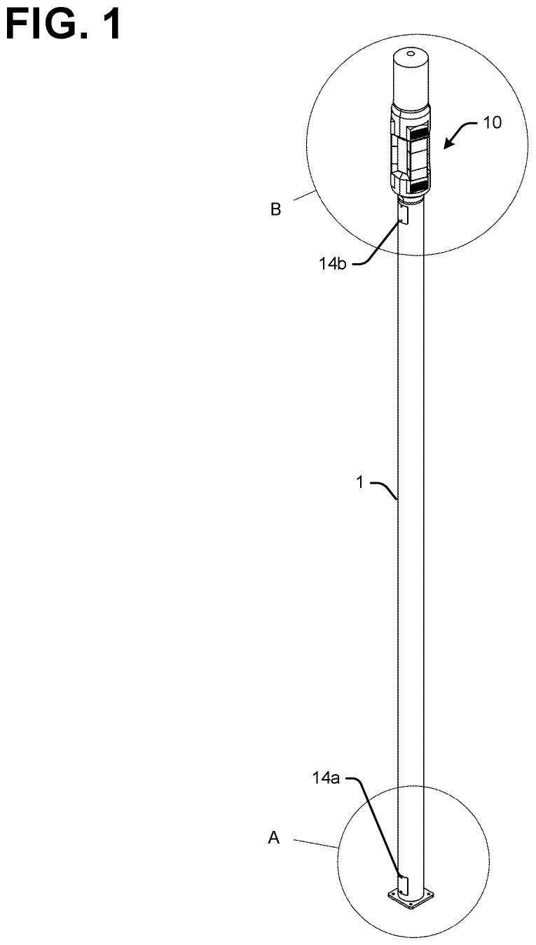

FIG. 1 shows an example telecommunications pole topper 10 mounted on a pole 1. The pole 1 may be a specially designated pole for telecommunications equipment, or an already existing pole such as provided for electrical power lines. The pole 1 may be wooden, metal, or made of any other suitable material. It is noted that the pole topper 10 is not limited to any type of pole or other mounting structure. The term “pole” as used herein may refer to any mounting structure for the telecommunications pole topper 10 regardless of the configuration.

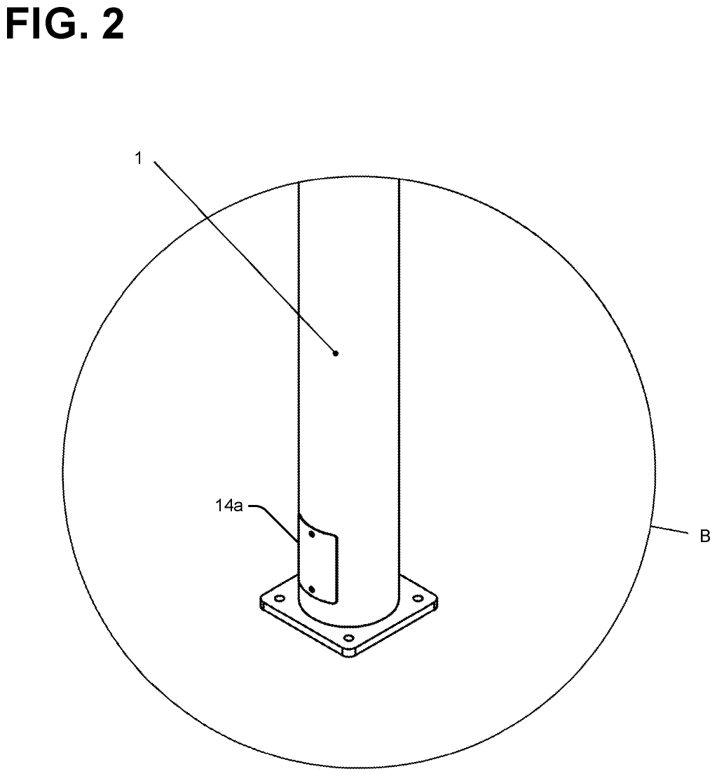

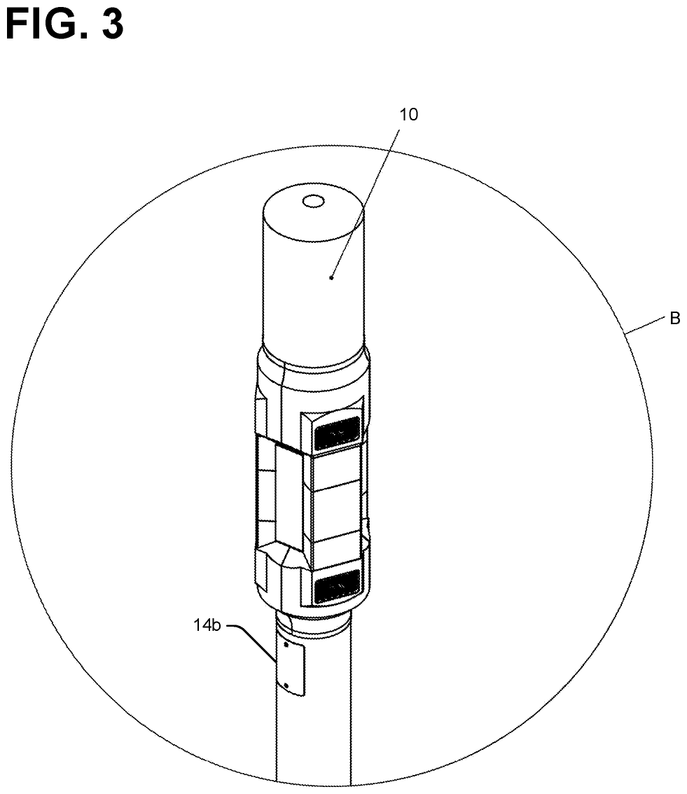

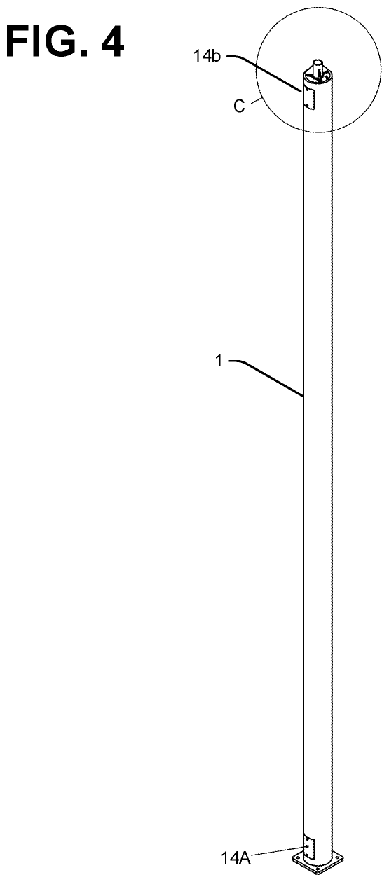

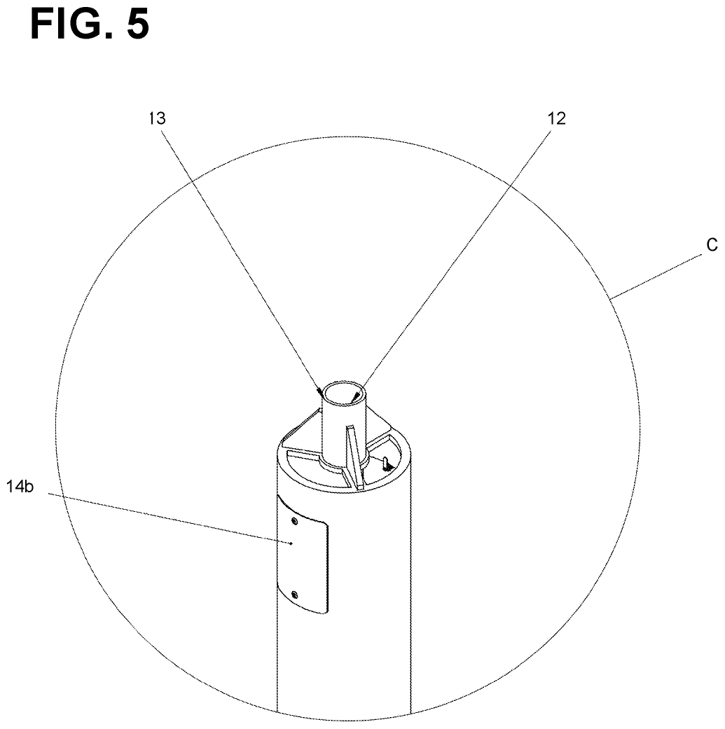

FIG. 2 is a detailed view of an example pole mounting area shown in detail area A in FIG. 1. FIG. 3 is a detailed view of the example telecommunications pole topper 10 shown in detail area B in FIG. 1. FIG. 4 shows an example mounting area for the telecommunications pole topper 10 on the pole 1. FIG. 5 is a detailed view of the example mounting area for the telecommunications pole topper 10 on the pole shown in detail area C in FIG. 4.

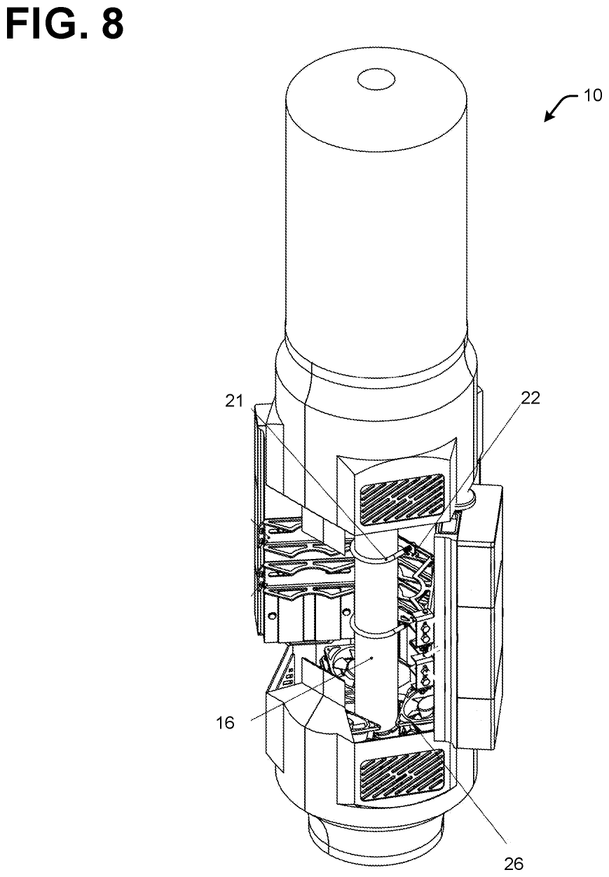

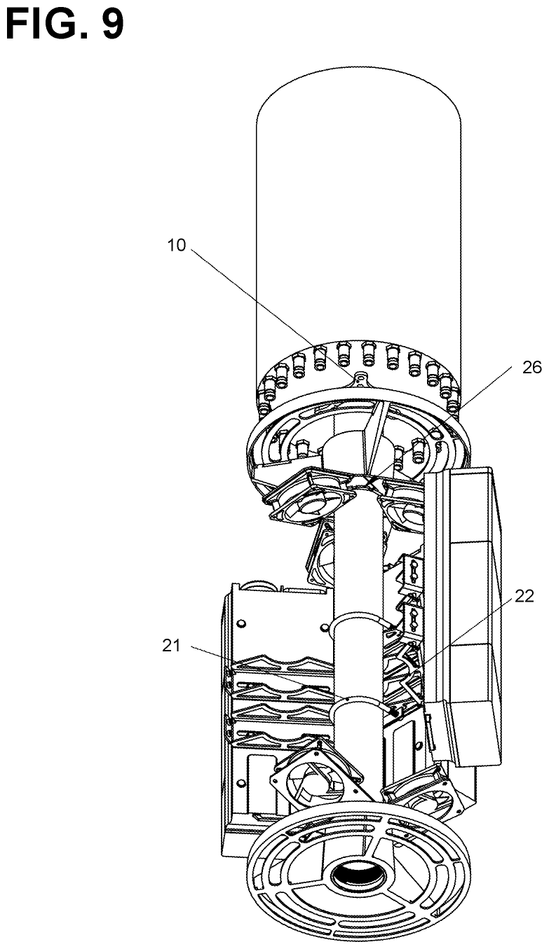

In this example, a mounting flange 12 may include a threading for receiving a centerline support structure 16 for mounting antennas (see, e.g., FIGS. 8-9). A shroud 18 encloses an interior space around the centerline support structure. In the example shown the shroud 18 is a tri-piece shroud. However, the shroud 18 is not limited to any number or portions.

In an example, the components described herein are manufactured of aluminum or steel, utilizing sand cast manufacturing techniques. However, other suitable materials and/or manufacturing techniques may be utilized and may depend on various design considerations, such as cost, end-use, strength, etc.

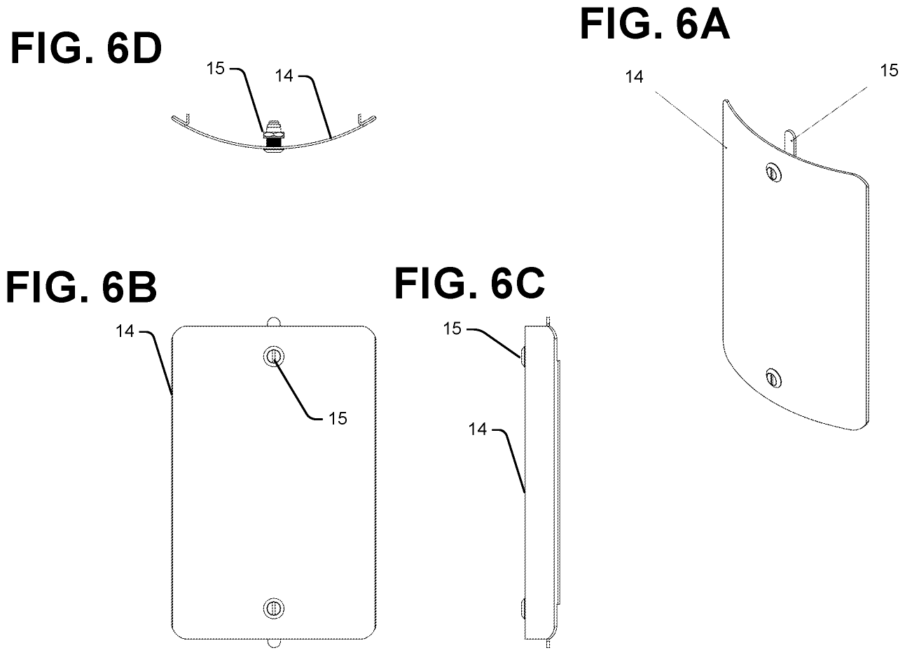

FIGS. 6A-D show an example pole cover which may be implemented with the telecommunications pole topper 10. Two pole covers 14a and 14b are shown in two example positions in FIG. 1 as these may be provided on the pole 1 to enable wiring and cables to be provided through the interior of the pole 1 from the ground or other source, to the top of the pole 1 where the telecommunications pole topper 10 is mounted. In an example, the pole covers 14a and 14b include a lock 15 to reduce unauthorized access to the wiring and cables.

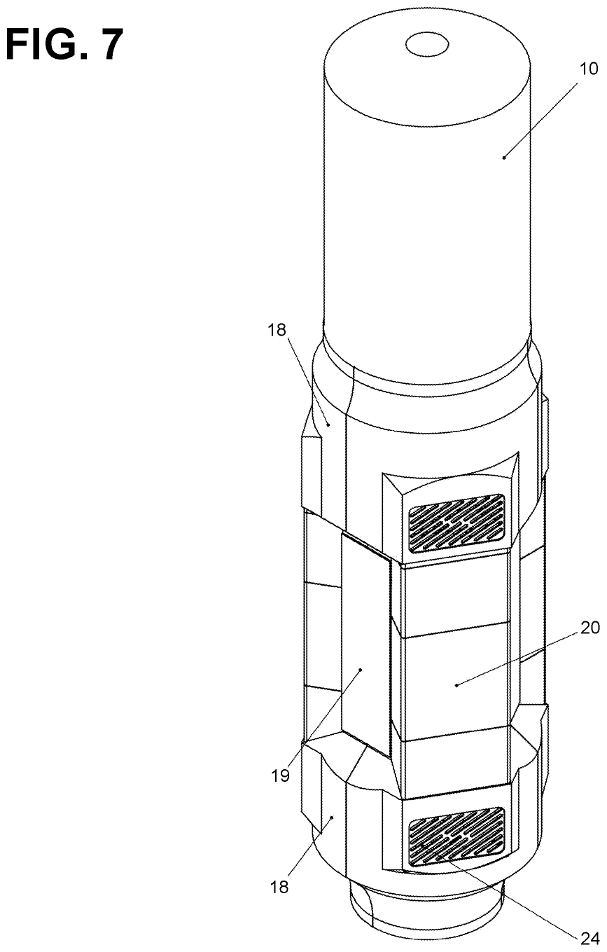

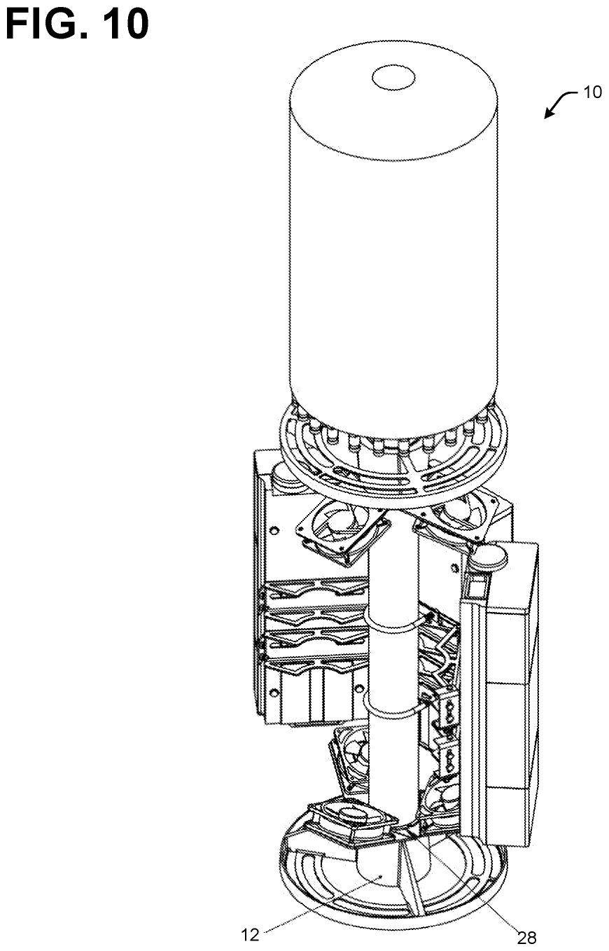

FIG. 7 is a close up perspective view of the example telecommunications pole topper 10 corresponding to FIGS. 1 and 3. FIG. 8 shows the example telecommunications pole topper 10 corresponding to FIG. 7, with a portion of the shroud 18 removed to show interior detail. FIG. 9 is a top perspective view showing the example telecommunications pole topper 10 corresponding to FIG. 7, with another portion of the shroud 18 removed to show interior detail. FIG. 10 is a bottom perspective view showing the example telecommunications pole topper 10 corresponding to FIG. 7, with another portion of the shroud 18 removed to show interior detail.

An example telecommunications pole topper 10 includes an axisymmetric centerline support structure 16 configured for mounting at least one telecommunications antenna 20. The axisymmetric configuration enables one or more antenna 20 to be positioned and repositioned to face any direction about the circumference of the centerline support structure 16. The antenna 20 may be mounted to the centerline support structure 16 using any suitable mount, such as but not limited to U-bolts 21 on brackets 22.

The example telecommunications pole topper 10 also includes a shroud 18 to close off an interior voided area formed between the shroud 18 and the centerline support structure 16. The shroud 18 can be a single or unitary structure with access panels 19 to provide access into the interior space. Ventilation is provided by one or more vent or grate 24. The ventilation grate 24 may be formed as part of the shroud 18, or provided over an opening formed in the shroud 18.

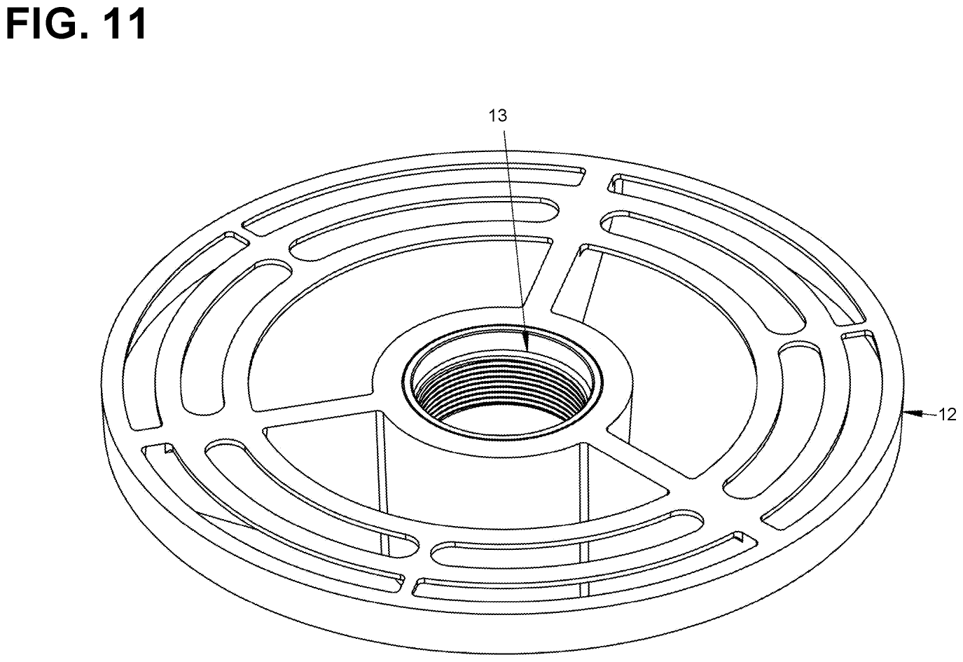

FIG. 11 is a perspective view of an example flange 12 (e.g., top or bottom assembly for the centerline support structure 16) of the example telecommunications pole topper 16. In an example, the flanges 12 have threads 13 that are accessible from both sides of the flange 12. This allows the flanges 12 to be universally attached with threaded pipe sections for attachment to different types of pole structures, or to other antenna mounting brackets.

In an example, the centerline support structure 16 has a casted mounting flange 12 that is threaded 13 both top and bottom for variable antenna height adjustment by only changing a length of the centerline support structure 16. The centerline support structure 16 may also have at least one end pipe section and at least one middle pipe section with a universal threading on each end. The middle pipe section connects to the end pipe section to add length to the centerline support structure 16.

In an example, the mounting flange 12 is threaded both top and bottom and works for both top and bottom mounting flanges of the pole topper 10. This allows for variable antenna height with no change to top or bottom geometry (e.g., only adjustment of pole length). This also allows for easy additions above and below with center thread and no additional hardware. In an example, threaded tubing connects the flanges 12. The centerline support structure 16 can thus be any height without needing to change any geometry other than the length.

As a result, the centerline support structure 16 within the shroud 18 accommodates different antenna sizes and shapes of telecommunications antennas 20 and different mounting configurations to support a plurality of telecommunications coverage patterns.

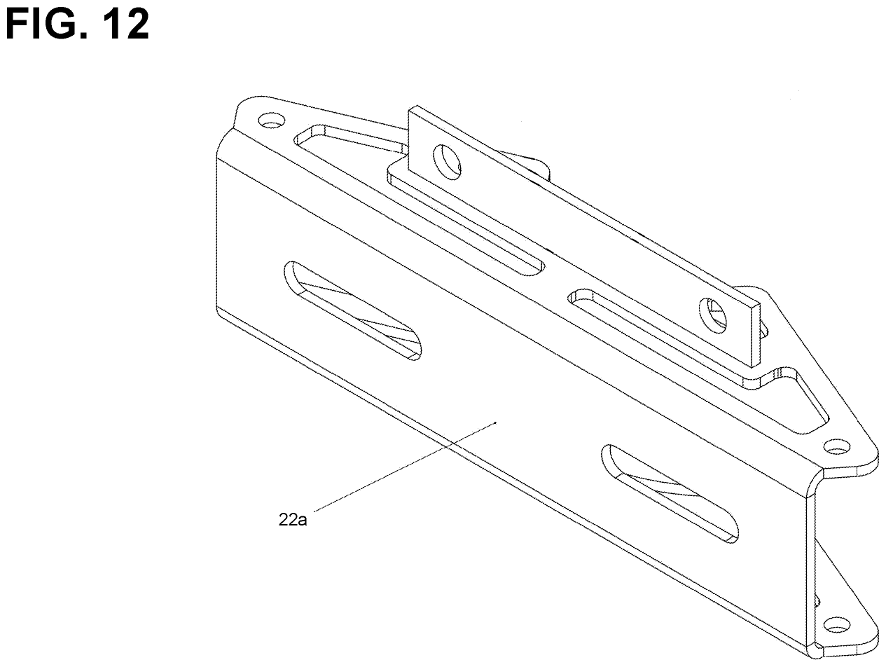

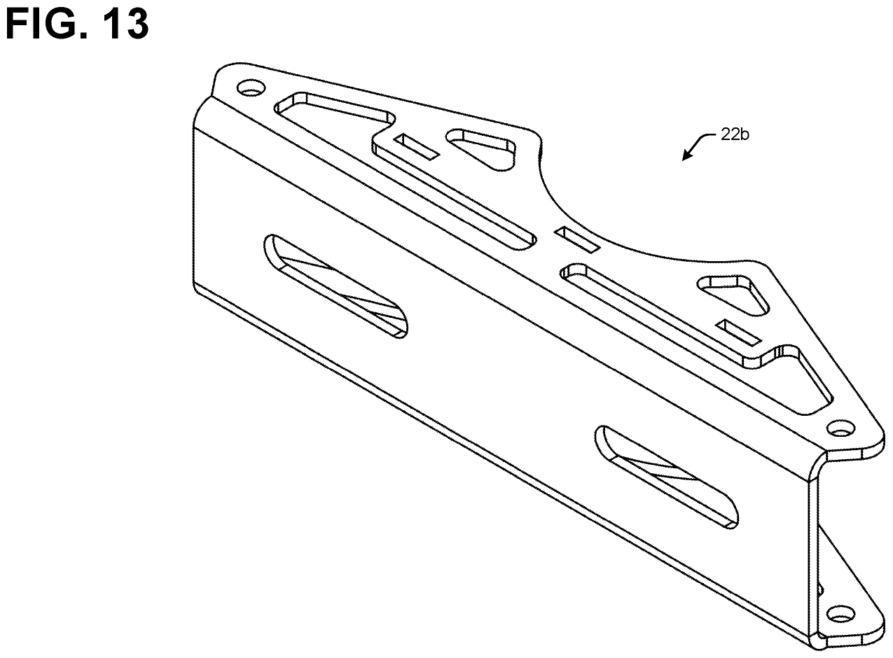

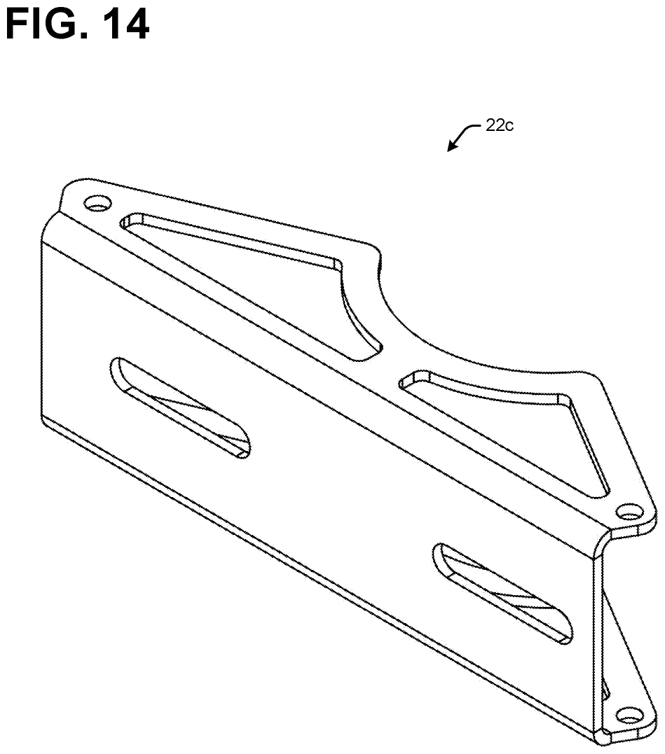

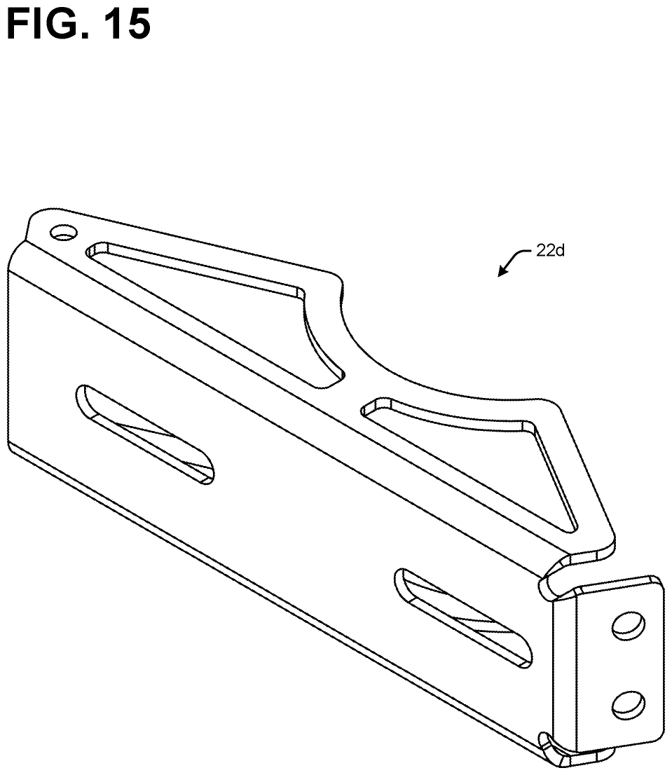

FIGS. 12-15 are perspective views of example brackets of the example telecommunications pole topper 10. FIG. 12 shows an example bracket configuration 22a. FIG. 13 shows an example bracket configuration 22b. FIG. 14 shows an example bracket configuration 22c. FIG. 15 shows an example bracket configuration 22d. These example bracket configurations 22a-d are referred to generally herein as bracket or bracketry 22. Still other bracket configurations are contemplated as being within the scope of the disclosure, as will be readily understood by those having ordinary skill in the art after becoming familiar with the teachings herein.

In an example, a universal internal bracket configuration allows for antennas to open for access behind the antenna structure. The bracketry support system may be slotted and configured with a friction connection, which allows for the brackets 22 to adjust and fit multiple antenna configurations. The brackets 22 can both slide horizontal and vertical to accommodate multiple antenna mounting hole locations on different antenna types.

In an example, the brackets 22 are three-axis adjustable bracketry that include an end bracket, flat cut then bent to fit to allow securing of the antenna assembly to the pole (e.g., with an impact driver or drill held perpendicular to pole face for ease of install).

In an example, a three faced hinged bracket 22 allows for three sectors to close together, providing a 120 degree bandwidth sector from the centerline support structure 16.

In an example, the bracket 22 is mounted to the centerline support structure 16 and is configured to move up and down and around the centerline support structure 16. The multiple-axis adjustable bracket 22, together with the centerline support structure 16, provides a mounting structure within the interior voided section of the shroud 18 for mounting the at least one telecommunications antenna 20 and other hardware such as electronics, cables, circuits, power, fans, etc., to the centerline support structure 16 for 360 degrees of rotation about the centerline support structure 16.

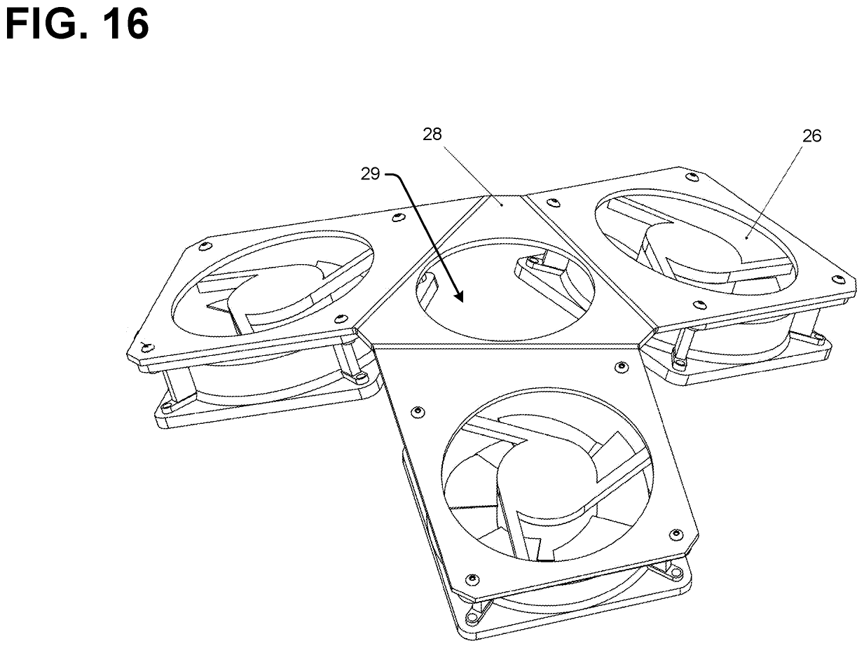

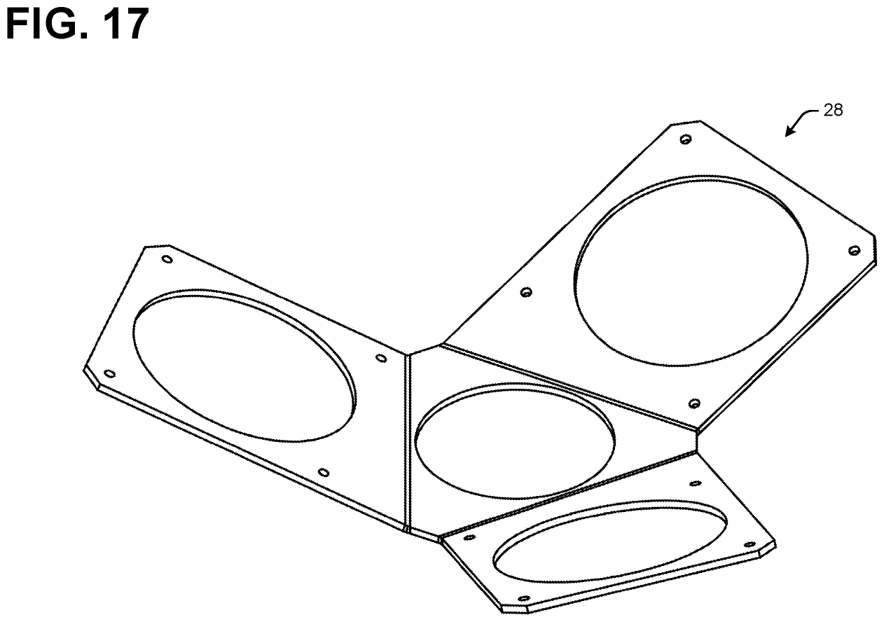

The example telecommunications pole topper 10 may also include at least one vortex fan 26 mounted to the centerline support structure 16 in the interior voided section of the shroud 18. FIGS. 16-17 are perspective views of an example vortex fan(s) 26 and support bracket 28 of the example telecommunications pole topper 10. In an example, the vortex fans 26 bring in cool air and pump out the hot air from inside the shroud. The configuration of bracket 28 causes vortex airflow for enhanced convection. The bracket 28 enables universal mounting for either top or bottom mounting positions on the centerline support structure 16.

In an example, the fan support bracket 28 is mounted to the centerline support structure 16 through opening 29. The fan support bracket 28 may have any suitable shape. In an example, the fan support bracket 28 is shaped as a lotus flower. The lotus flower shape enables a vortex airflow through the interior space within the shroud 18. One or more fans may be mounted to the fan support bracket. In an example, the fan support bracket 28 is tilted so that the fan(s) 26 direct airflow towards the centerline support structure 16.

In an example, each fan mount of the fan support bracket 28 is pitched (e.g., as seen in FIGS. 16 and 17) so that the fan generates a vortex airflow circulation in the interior voided area. In an example, a second fan support bracket is also provided. The upper and lower fan support brackets 28 may form a mirrored fan configuration (e.g., facing one another from top and bottom of the centerline support structure 16) for generating a vortex airflow inside the interior voided area.

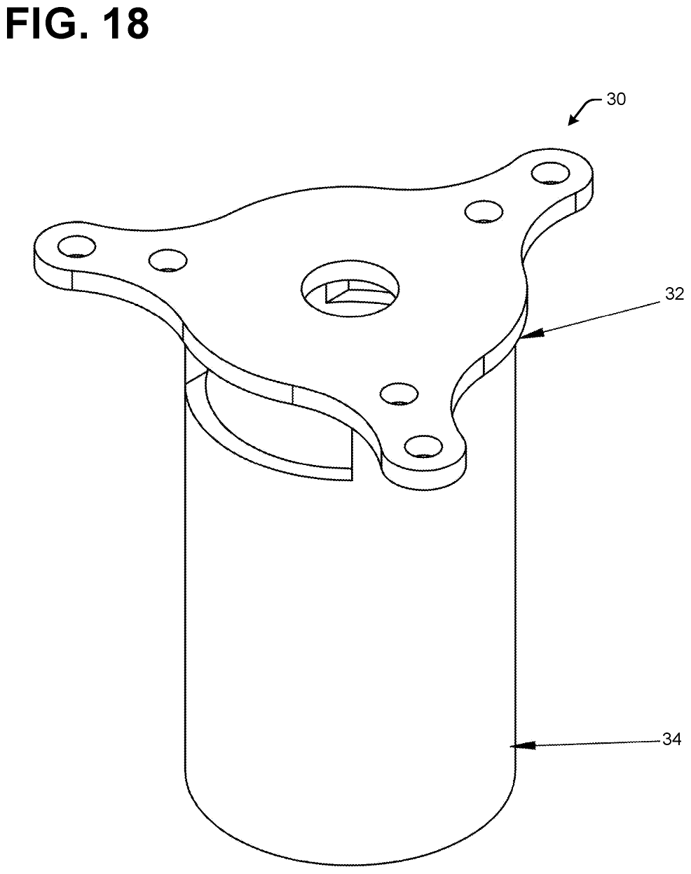

FIG. 18 is a perspective view of an example antenna attachment assembly 30 of the example telecommunications pole topper 10. In an example, the antenna attachment assembly 30 includes an omni-antenna plate 32 mounted on post 34. The post 34 can be attached (e.g., threads) directly into the center thread of the flange 18 without need for any extra hardware to add this feature. An omni-directional antenna (not shown) may be mounted to the plate 32 at the top of the telecommunications pole topper 10.

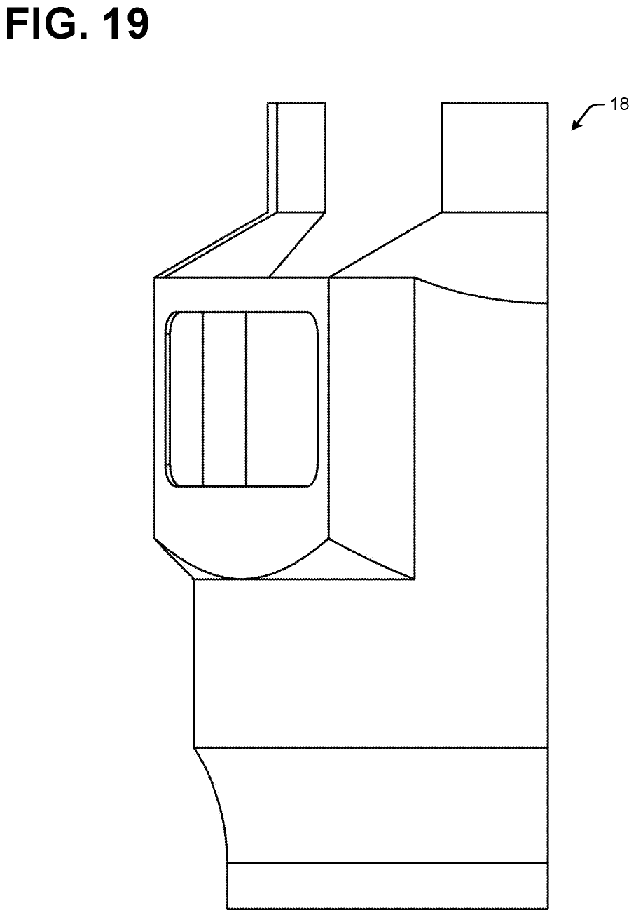

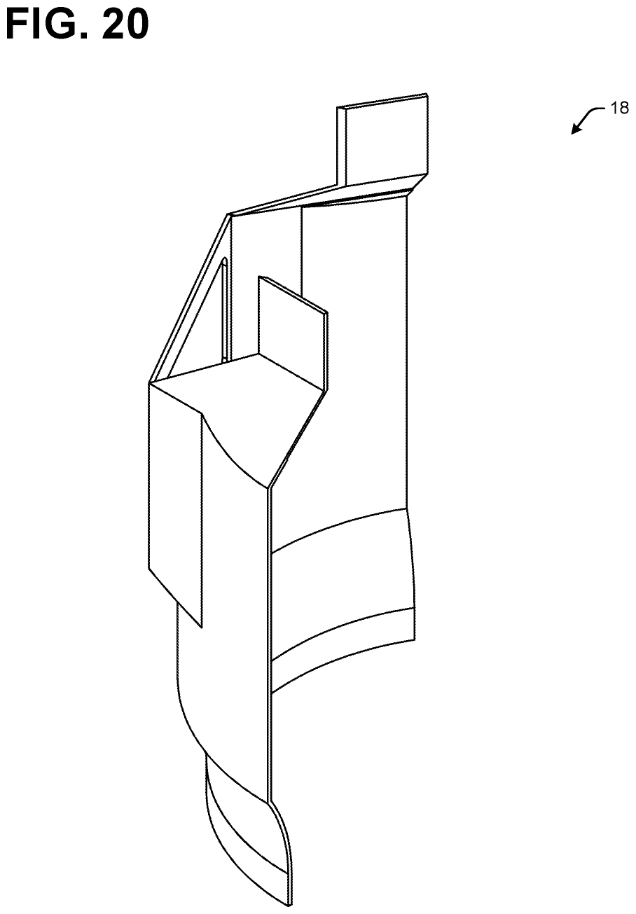

FIGS. 19 and 20 are perspective views of an example shroud 18 of the example telecommunications pole topper 10. The shroud 18 may be made of ABS or other plastic shroud, and closes off all voided sections of the antennas. The shroud 18 may have ventilation ports to allow for optimal airflow.

The shrouds 18 are universal and can be used interchangeably with one another. In an example, a tri-piece design of the shrouds 18 allows easy removal or opening to access the interior space without full removal of all of the shrouds 18.

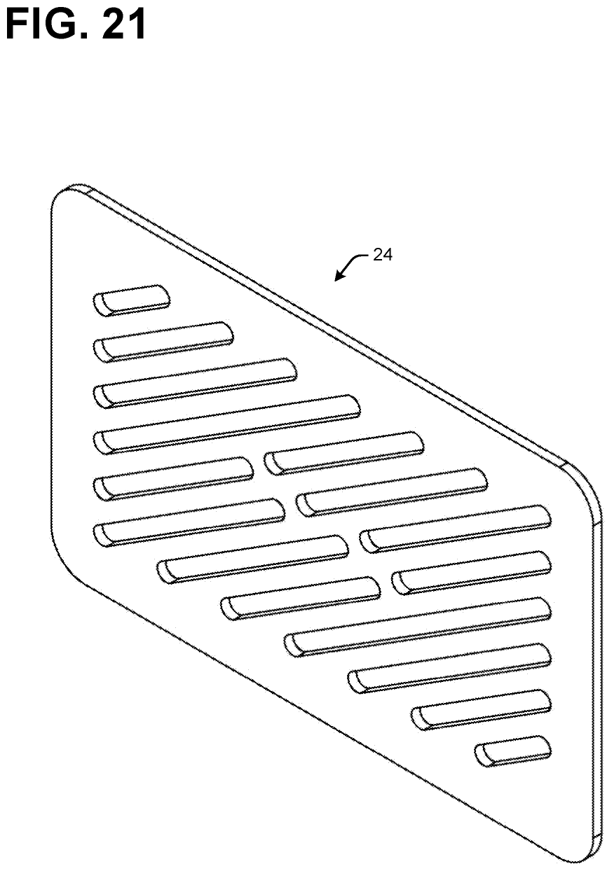

FIG. 21 is a perspective view of an example grate 24 for the shroud 18 of the example telecommunications pole topper 10. The exhaust and air intake allows for independent function of the pole topper 10 without impact on components above or below.

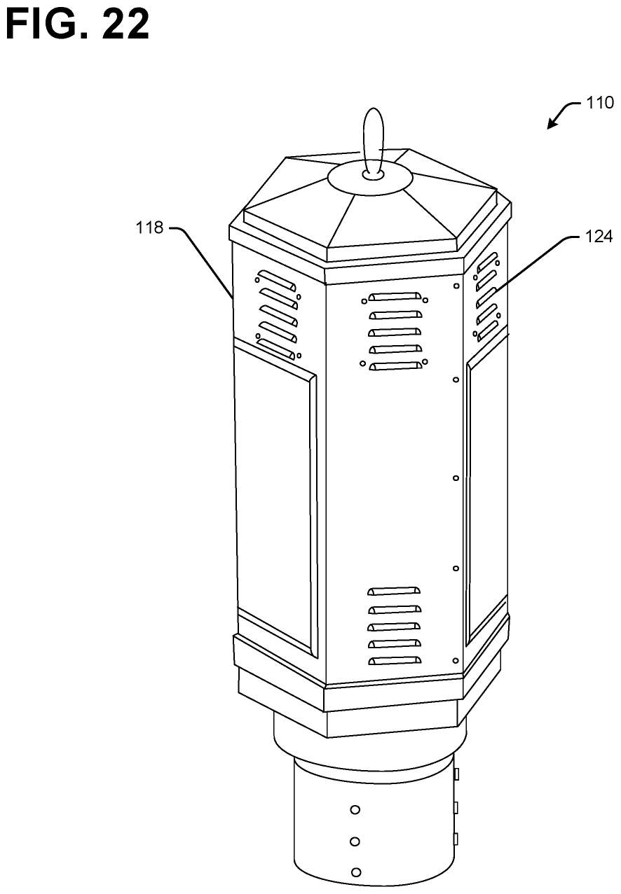

FIG. 22 shows another example telecommunications pole topper 110. An example of the telecommunications pole topper system 110 includes a housing for an axisymmetric centerline support structure 116 configured for mounting at least one telecommunications antenna in an interior of the housing. In an example, the telecommunications pole topper 110 also accommodates different antenna sizes and shapes of telecommunications antennas and different mounting configurations to support a plurality of telecommunications coverage patterns.

The example pole topper 110 is lightweight and provides cost effective installation and maintenance of telecommunications antennas (e.g., 5G). Telecommunications device heat transfer is optimized by vortex circulation. The structure is readily open for easy access behind antennas. Sand cast components enable mass production for cost effectiveness.

In an example, the antennas and shrouds are free to rotate or move up and down on the pole to accommodate antenna size or best coverage pattern without adjustment of the topper structure or mounting flange. Universal shrouds that match top and bottom, fit any topper height.

An example of the telecommunication pole topper may include a reflective insulation material on the inside of the shroud to create a barrier from the sun rays contributing to an increase in thermal buildup on the inside of the structure.

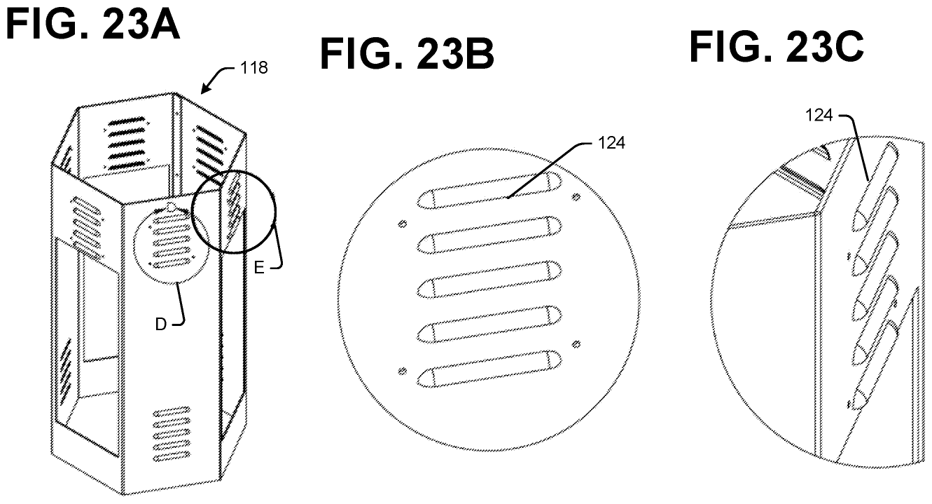

FIG. 23A shows an example shroud 118 of the example telecommunications pole topper 110 shown in FIG. 22. FIG. 23B is a detailed view of an example vents 124 of the shroud 118 shown in detail area D in FIG. 23A. FIG. 23C is a detailed view of an example vents 124 of the shroud 118 shown in detail area E in FIG. 23B.

Polycarbonate, ABS or other plastic shroud 118 closes off all voided sections of the antennas. The shroud 118 may have ventilation ports or louvers to allow for optimal airflow.

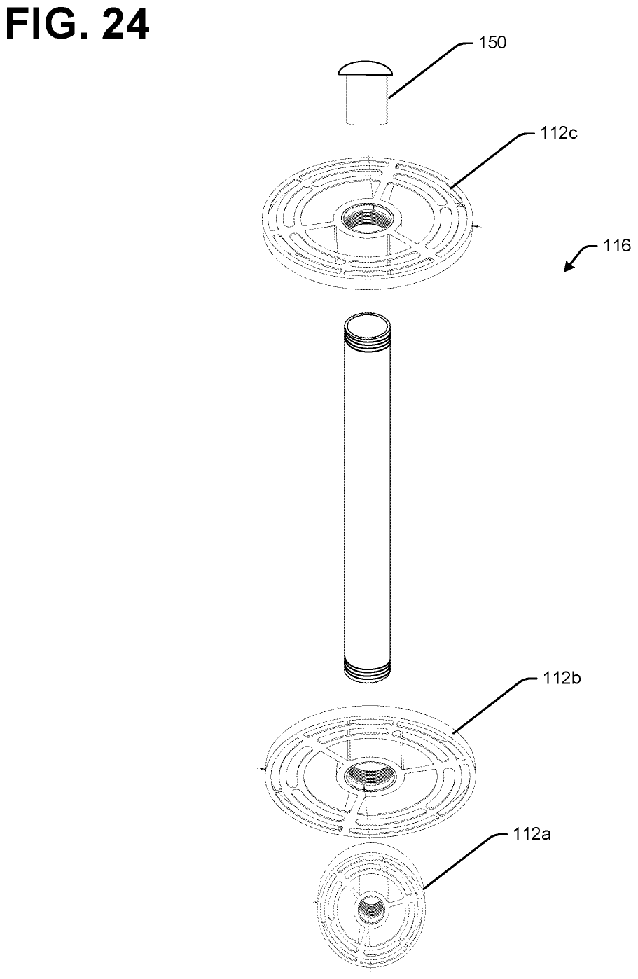

FIG. 24 is an exploded perspective view of an example internal structure 116 of the example telecommunications pole topper 110 shown in FIG. 22. At least one universal multiple-axis adjustable bracket (not shown, but see e.g., bracketry 22 in earlier Figures) is configured to move up and down and around the centerline support structure 116. The multiple-axis adjustable bracket together with the centerline support structure 116 provide a mounting structure within the interior of the housing or shrouds 118 for mounting at least one telecommunications antenna to the centerline support structure 116 for 360 degrees of rotation about the centerline support structure 116.

An example of the telecommunications pole topper 110 is manufactured of aluminum or steel, utilizing a sand cast flange base, and internal threads for easy threaded connections. The centerline support structure 116 is axisymmetric for 360 degree antenna adjustment. The universal internal bracketry 122 allows for antennas to open for access behind the antenna structure. The antenna bracket 122 can both slide horizontal and vertical to accommodate multiple antenna mounting hole locations on different antenna types.

The mid portion of the shroud 118 is manufactured through a cold forming process to include louvers 124 in the shroud 118, as well as make the shroud 118 a one-piece system. The polycarbonate shroud 118 is supported by flanges 112a-c and a slip fit and top cap connection to reduce hardware and simplify fit up and access.

A bottom portion of the shroud 118 may be made from similar materials and is supported by the lower cast flange 112b and is also a slip fit over the polycarbonate shroud 118 for securing. The bottom portion is not limited to material types, as the bottom portion of the shroud 118 is intended to only cover the telecommunication cables and not necessarily intended for ventilation.

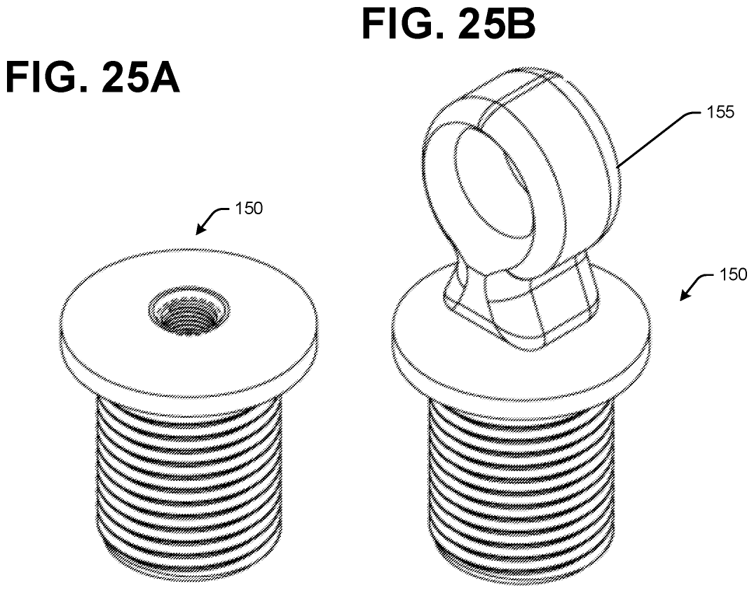

In an example, 150 a lifting point for the centerline support structure enables it to be picked up and installed on a pole. FIG. 25A is a detailed perspective view of an example hanger 150 of the internal structure 116 shown in FIG. 24. FIG. 25B is a detailed perspective view of the example hanger 150 shown in FIG. 25A with a threaded eye-bolt 155.

In an example, the 116 support structure and shroud 118 are connected and supported by a top threaded cap 150 which is integrated into the cast flange 112c so that it can be tightened by hand with no need for tools. The threaded cap 150 can also receive an eyelet 155 provided to allow for the topper to be picked and installed by the top.

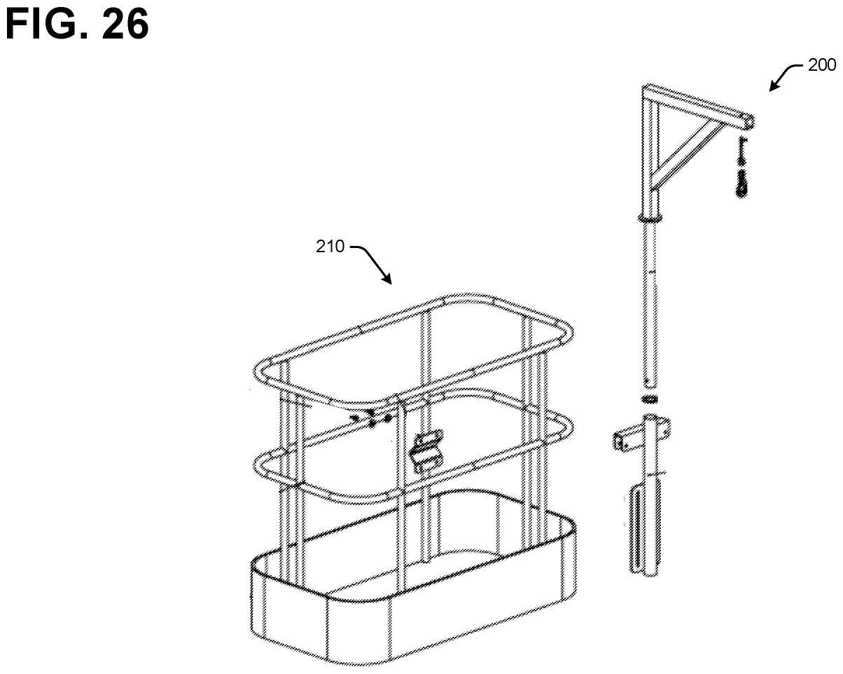

In an example, a universal installation tool 200 is configured to attach to a crane basket 210 and lift the centerline support structure 116 by the lifting point 155 for mounting to the pole 1. FIG. 26 is a perspective view of an example crane basket 210 which may be implemented to install the example telecommunications pole topper shown in FIG. 22.

In an example, the universal installation tool 200 is provided to hang from a man basket 210 that allows the installer to pick the topper 110 from the eyelet 155 using a small lightweight davit style crane. In an example, the universal installation tool 200 may be detachable from the man basket 210 so it can be used on multiple different types of equipment for installation contractors.

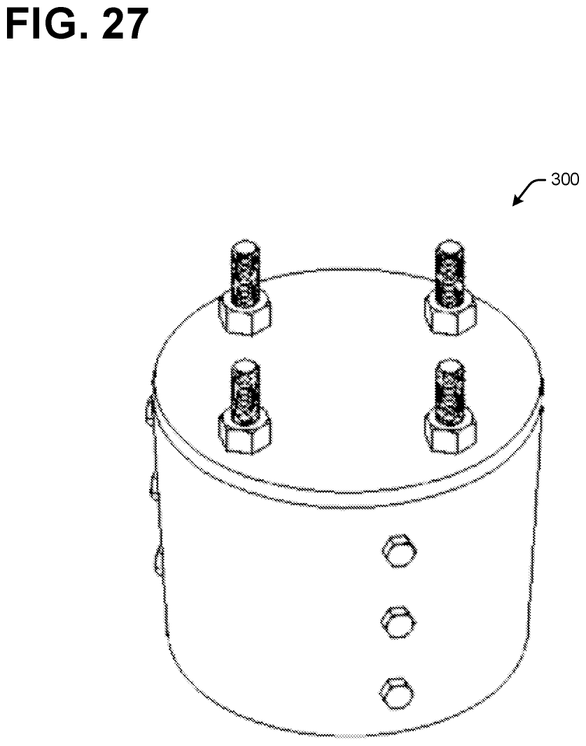

FIG. 27 is a drawing of an example pole cap 300 that may be implemented to self-level a telecommunications pole topper 10 or 110 on an existing pole 1 (e.g., a wood pole). Wood poles in the industry can be inherently crooked and not plumb. This cap 300 levels a topper 10 or 110 and structurally connects the topper 10 or 110 to the pole 1. In an example, the cap 300 may be implemented with existing or new wood pole structures, and integrates and structurally connects a topper to wood structures.

In an example, the cap 300 may be manufactured of cast aluminum or other suitable material. The cap 300 includes threaded studs (e.g., 3 or 4 studs) that protrude vertically from the cap to allow for independently leveling an existing pole to a new topper. The cap 300 may hold the shroud without need for any hardware on the sides of the pole 1.

The structural connection from the cap 300 to the wood pole structure works via a series of lag bolts or fasteners that center the cap and anchors it into the wood structure 1 to create a structural connection (e.g., to handle the wind loading).

The cap 300 may be configured as a main pole attachment that is a cast component with a large spherical opening that allows for cables to pass through with plenty of room. The cap 300 is a universal connector which can be used for both steel and wood pole connections.

It is noted that the examples shown and described are provided for purposes of illustration and are not intended to be limiting. Still other examples are also contemplated.

1. A telecommunications pole topper, comprising:
an axisymmetric centerline support structure configured for mounting at least one telecommunications antenna;
a shroud to close off an interior voided area formed between the shroud and the centerline support structure;
a universal multiple-axis adjustable bracket configured to move up and down and around the centerline support structure when mounted thereto, the multiple-axis adjustable bracket together with the centerline support structure providing a mounting structure within the interior voided section of the shroud for mounting the at least one telecommunications antenna to the centerline support structure for 360 degrees of rotation about the centerline support structure;
wherein the centerline support structure within the shroud accommodates different antenna sizes and shapes of telecommunications antennas and different mounting configurations to support a plurality of telecommunications coverage patterns.

2. The telecommunications pole topper of claim 1, further comprising a ventilation grate to provide airflow through the shroud.

3. The telecommunications pole topper of claim 1, further comprising at least one vortex fan mounted to the centerline support structure in the interior voided section of the shroud.

4. The telecommunications pole topper of claim 1, wherein the adjustable bracket has a slotted mount configured with a friction connection to fit and adjust multiple different antenna configurations on the centerline support structure.

5. The telecommunications pole topper of claim 1, wherein the adjustable bracket has a three faced hinged adapter for mounting three sectors to close together while providing a 120 degree bandwidth sector from the centerline support structure.

6. The telecommunications pole topper of claim 1, wherein adjustable bracket slides both horizontally and vertically on the centerline support structure to accommodate multiple different antenna mounting locations for different antenna types.

7. The telecommunications pole topper of claim 1, wherein the centerline support structure has a casted mounting flange that is threaded both top and bottom for variable antenna height adjustment by only changing a length of the centerline support structure.

8. The telecommunications pole topper of claim 7, wherein the centerline support structure has at least one end pipe section and at least one middle pipe section with a universal threading on each end, the at least one middle pipe section connecting to the at least one end pipe section to add length to the centerline support structure.

9. The telecommunications pole topper of claim 1, further comprising a fan support bracket mounted to the centerline support structure, the fan support bracket shaped as a lotus flower.

10. The telecommunications pole topper of claim 9, further comprising at least one fan mounted to the fan support bracket, wherein the fan support bracket is tilted so that the at least one fan directs airflow towards the centerline support structure.

11. The telecommunications pole topper of claim 10, wherein the fan support bracket is pitched so that the at least one fan generates a vortex airflow circulation in the interior voided area.

12. The telecommunications pole topper of claim 11, further comprising a second fan support bracket, the fan support brackets forming a mirrored fan configuration for generating a vortex airflow inside the interior voided area.

13. The telecommunications pole topper of claim 1, further comprising a pole cap to mount on and self-level an existing pole for attaching the centerline support structure.

14. The telecommunications pole topper of claim 1, wherein the centerline support structure and shroud are connected together and supported by a top cap.

15. The telecommunications pole topper of claim 14, wherein a connection for the top cap is integrated into a cast flange of the centerline support structure.

16. The telecommunications pole topper of claim 14, wherein the top cap is removable for interchanging with an eyelet, the eyelet providing a lifting point for the centerline support structure to be picked up and installed on a pole.

17. A telecommunications pole topper system, comprising:
a housing for an axisymmetric centerline support structure configured for mounting at least one telecommunications antenna in an interior of the housing;
at least one universal multiple-axis adjustable bracket configured to move up and down and around the centerline support structure when mounted thereto, the multiple-axis adjustable bracket together with the centerline support structure providing a mounting structure within the interior of the housing for mounting the at least one telecommunications antenna to the centerline support structure for 360 degrees of rotation about the centerline support structure.

18. The telecommunications pole topper system of claim 17, wherein the centerline support structure and housing accommodates different antenna sizes and shapes of telecommunications antennas and different mounting configurations to support a plurality of telecommunications coverage patterns.

19. The telecommunications pole topper system of claim 18, further comprising a lifting point for the centerline support structure to be picked up and installed on a pole.

20. The telecommunications pole topper system of claim 19, further comprising a universal installation tool configured to attach to a crane basket and lift the centerline support structure by the lifting point for mounting to the pole.
